(19) United States
(12) Patent Application Publication
(10) Pub. No.: US 2010/0289750 A1
(43) Pub. Date: Nov. 18, 2010

(54) Touch Type Character Input Device

(76) Inventor: Hyung Gi Kim, Seoul (KR)

Correspondence Address: PARK LAW FIRM, 3255 WILSHIRE BLVD, SUITE 1110, LOS ANGELES, CA, 90010, US

(21) Appl. No.: 12/376,416

(22) PCT Filed: Nov. 24, 2006
(86) PCT No.: PCT/KR06/04962

§ 371 Date: Feb. 4, 2009

(30) Foreign Application Priority Data
Aug. 4, 2006 (KR) 10-2006-0073651
Aug. 17, 2006 (KR) 10-2006-0077486

(51) Int. Cl. G06F 3/041

(52) U.S. Cl. 345/173

(57) ABSTRACT

Disclosed herein is a touch type character input device for expediently inputting characters through a touch type user input device such as a touch screen or a touch pad. The touch type character input device has a touch region where a coordinate is designated or a character is selected using a finger or a tool so as to input the character or the coordinate to a main device. Also the touch type character input device comprises: a first manipulation region defined by a first closed curve within the touch region, a second manipulation region defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character; an input processing section adapted to designate a current character, set an input language mode, or change the position of a cursor in response to a touch signal generated in the first and second manipulation regions; and a character display section adapted to display the current character designated by the input processing section thereon.

### TECHNICAL FIELD

The present invention relates to a touch type character input device, and more particularly, to such a device for expediently inputting characters through a touch type user input device such as a touch screen or a touch pad.

This application claims priority to Korean Patent Application No. 10-2006-73651, filed with the Korean Intellectual Property Office (KIPO) on Aug. 4, 2006, has been filed with KIPO on Aug. 17, 2006 (Korean Patent Application No. 10-2006-77488), and has been registered with KIPO on Nov. 13, 2006 (Korean Patent Registration No. 10-647827), the entire disclosure of which is incorporated herein by reference.

Currently, a representative example of a device for inputting characters (which may be also referred to as a “letters”) on a touch sensitive basis is a personal digital assistant (PDA). However, along with a trend toward making various devices suitable for a graphic user interface (GUI) environment, a touch screen is widely applied to a variety of devices navigators, point-of-sale (POS) devices, automatic teller machines (ATMs), cellular phones and the like so as to input characters to these devices.

### BACKGROUND ART

In general, the reason why a touch type user input device is applied to input characters is that a device is small-sized or a space where to install a keyboard is not sufficiently large.

Such a touch type user input device detects a coordinate of a contact point on a screen where a user touches or whether or not he or she touches the screen using an infrared-ray, a resistor film, a supersonic wave, etc.

In case where the touch type user input device is used, a user's finger or a stylus pen. A stylus pen is mainly used for a small-sized device so that a user can more precisely select a point indicated within a touch region on the screen due to a limited size of an input region of the touch type user input device, i.e., a touch sensitive region.

There are various methods of inputting characters using a touch screen in the touch type user input device. such a character-inputting method is largely divided into a method of selecting a unit character provided on a touch screen (hereinafter, referred to as “selection-based input method”) and a method of directly writing a character in a designated region of a touch screen to recognize the character (hereinafter, referred to as “writing-based input method”).

Examples of the writing-based input method include a graffiti input method which has been proposed and used by Palm Co., i.e., a PDA manufacturer, a character recognition system used in Windows CE, etc. However, such a writing-based input method has a shortcoming in that it is difficult to characters and there is a high possibility that a recognition result may be erroneous. In case of PDAs manufactured by Palm Co., it is required that a separate sticker peculiar to the graffiti input method should be attached on the PDA. Since it is required that a separate window where a user can write a desired characters be included on a touch screen or be configured of a touch pad in a separate position of PDA, the touch screen is not used efficiently and a device becomes large in size.

Examples of the selection-based input method include a method of inputting characters by depressing a corresponding key arranged on a transparent virtual keyboard displayed on a touch screen such as Korean Patent No. 509198 shown in FIG. 1, and a Cirrin method of inputting desired ones of English alphabet characters arranged in a donut shape using a stylus pen as shown FIG. 2.

FIG. 2 is a view illustrating a process of inputting a word called “cirrin”.

In addition, the selection-based input method includes a T-cube method as shown in

FIG. 3. In FIG. 3(a), nine regions includes keys allocated to respective submenus shown in FIG. 3(b) so that when a predetermined region of FIG. 3(a) is depressed, a corresponding submenu of FIG. 3(b) appears so as to allow a user to input a desired character.

Such a conventional selection-based input method entails problems in that since a number of characters must be disposed or a lot of submenus must be separately provided in a limited region for the purpose of their selection, in case of using a multiple of letters such as the English alphabet consisting of a total of twenty-six letters or the Korean alphabet, i.e., Hangeul consisting of a total of twenty-four letters, a spacing between adjacent letters is inevitably decreased, and hence it is difficult to accurately depress a desired character, which results in an increased generation of erroneous entry.

### DISCLOSURE OF INVENTION

### Technical Problem

Accordingly, the present invention has been made to solve the aforementioned problems occurring in the prior art, and it is a primary object of the present invention to provide a touch type character input device in which when a user did not accurately depress a character that he or she wants to input, such a depressing error can be corrected easily and simply.

Another object of the present invention is to provide a touch type character input device which enables a user to select a representative character and then input the associated characters of the representative character.

### Technical Solution

To accomplish the above object, according to one aspect of exemplary embodiments of the present invention, there is provided a touch type character input device having a touch region where a coordinate is designated or a character is selected using a finger or a tool so as to input the character or the coordinate to a main device, the touch type character input device comprising:

a first manipulation region formed at the central portion of the touch region in such a fashion as to be defined by a first closed curve within the touch region;

a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character;

an input processing section adapted to designate a current character, set an input language mode, or change the position of a cursor in response to a touch signal generated in the first and second manipulation regions; and

a character display section adapted to display the current character designated by the input processing section thereon,

wherein when one character sector is first depressed at the second manipulation region, the input processing section designates a representative character allocated to the depressed character sector as a current character to cause the designated current character to be displayed on the character display section,

wherein in case where the current character displayed on the character display section is not identical to a character which a user wants to input, when the depressed position of the touch region is shifted to another position at the second manipulation region while maintaining the depressed state of the touch region, the input processing section designates a representative character adjacent to the representative character allocated to the first depressed character sector as the current character, and

wherein when the depressed state of the touch region is released within the second manipulation region, the input processing section transmits a code of a finally designated current character to the main device.

To accomplish the above object, according to another aspect of exemplary embodiments of the present invention, there is also provided a touch type character input device having a touch region where a coordinate is designated or a character is selected using a finger or a tool so as to input the character or the coordinate to a main device, the touch type character input device comprising:

a first manipulation region formed at the central portion of the touch region in such a fashion as to be defined by a first closed curve within the touch region;

a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character; and

an input processing section adapted to designate a current character, set an input language mode, or change the position of a cursor in response to a touch signal generated in the first and second manipulation regions,

wherein when one character sector is first depressed at the second manipulation region, the input processing section designates a representative character allocated to the depressed character sector as a current character to cause a code of the designated current character to be transmitted to the main device,

wherein in case where the current character transmitted to the main device is not identical to a character which a user wants to input, when the depressed position of the touch region is shifted to another position at the second manipulation region while maintaining the depressed state of the touch region, the input processing section designates a representative character adjacent to the representative character allocated to the first depressed character sector as the current character, and

wherein when the current character is designated, the input processing section transmits a code of the previously designated current character to the main device along with a code required to cause the display state of the main device to return to an original state in which the previously designated current character was not transmitted to the main device.

Preferably, in case where the number of the associated characters of a selected representative character is one, the selected representative character positioned at the second manipulation region is designated as a current character and then the depressed position of the touch region is shifted to the first manipulation region while maintaining the depressed state of the touch region to cause the associated character of the selected representative character to be designated as a current character.

Preferably, in case where the number of the associated characters of a selected representative character is one, the selected representative character positioned at the second manipulation region is designated as a current character and then the depressed position of the touch region is shifted to the first manipulation region and re-shifted to the second manipulation region while maintaining the depressed state of the touch region to cause the associated character of the selected representative character to be designated as a current character.

Preferably, in case where the number of the associated characters of a selected representative character is plural, the selected representative character positioned at the second manipulation region is designated as a current character and then the depressed position of the touch region is shifted to the first manipulation region and re-shifted to the second manipulation region while maintaining the depressed state of the touch region, so that the associated characters of the selected representative character prior to the shifting of the depressed position of the touch region to the first manipulation region are allocated to the divided character sectors of the second manipulation region to cause a corresponding one of the associated characters of the selected representative character to be designated as a current character so as to be displayed on the character display section,

if the current character displayed on the character display section is not identical to a character which the use wants to input, the user repeatedly changes the depressed position at the second manipulation region while maintaining the depressed state of the touch region until the character which the use wants to input is displayed on the character display section to cause a corresponding one of the associated characters of the selected representative character to be designated as the current character, and

if the depressed state of the touch region is released, the representative characters of the second manipulation region are again allocated to the character sectors of the second manipulation region.

Also, preferably, when the first manipulation region is first depressed and the depressed position of the touch region is shifted to the second manipulation region while maintaining the depressed state of the touch region, the input language mode is changed to allow the representative characters of the changed input language to be allocated to the character sectors of the second manipulation region.

Preferably, the input language mode is changed before the depressed state of the touch region is released at the second manipulation region, and the representative characters of the changed input language are allocated to the character sectors of the second manipulation region to allow one of the representative characters of the changed input language to be designated an a current character, and

if the designated current character is not identical to a character which the user wants to input, the depressed position of the touch region is shifted at the second manipulation region while maintaining the depressed state of the touch region to allow the character which the user wants to input is designated as the current character, and when the depressed state of the touch region is released, the input language mode is re-changed to an original input language mode to allow the representative characters of the input language prior to the change of the input language mode to be allocated to the character sectors of the second manipulation region.

To accomplish the above object, according to still another aspect of exemplary embodiments of the present invention, there is also provided a touch type character input device having a touch region where a coordinate is designated or a character is selected using a finger or a tool so as to input the character or the coordinate to a main device, the touch type character input device comprising:

a first manipulation region formed at the central portion of the touch region in such a fashion as to be defined by a first closed curve within the touch region;

a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character;

a third manipulation region formed at the peripheral portion of the touch region in such a fashion as to be defined by a third closed curve so as to surround the second manipulation region within the touch region, the third manipulation region being the remaining area other than the first and second manipulation regions among the area surrounded by the third closed curve and consisting of a plurality of character sectors each allocated with a corresponding representative character of an input language different from the representative characters allocated to the character sectors of the second manipulation region;

an input processing section adapted to designate a current character, set an input language mode, or change the position of a cursor in response to a touch signal generated in the manipulation regions; and

a character display section adapted to display the current character designated by the input processing section thereon,

wherein when one character sector is first depressed at the second manipulation region or the third manipulation region, the input processing section designates a representative character allocated to the depressed character sector as a current character to cause the designated current character to be displayed on the character display section,

wherein in case where the current character displayed on the character display section is not identical to a character which a user wants to input, when the depressed position of the touch region is shifted to another position within the corresponding manipulation region while maintaining the depressed state of the touch region, the input processing section designates a representative character adjacent to the representative character allocated to the first depressed character sector as the current character, and

wherein when the depressed state of the touch region is released within the corresponding manipulation region, the input processing section transmits a code of a finally designated current character to the main device.

To accomplish the above object, according to yet another aspect of exemplary embodiments of the present invention, there is also provided a touch type character input device having a touch region where a coordinate is designated or a character is selected using a finger or a tool so as to input the character or the coordinate to a main device, the touch type character input device comprising:

a first manipulation region formed at the central portion of the touch region in such a fashion as to be defined by a first closed curve within the touch region;

a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character;

a third manipulation region formed at the peripheral portion of the touch region in such a fashion as to be defined by a third closed curve so as to surround the second manipulation region within the touch region, the third manipulation region being the remaining area other than the first and second manipulation regions among the area surrounded by the third closed curve and consisting of a plurality of character sectors each allocated with a corresponding representative character of an input language different from the representative characters allocated to the character sectors of the second manipulation region; and

an input processing section adapted to designate a current character, set an input language mode, or change the position of a cursor in response to a touch signal generated in the manipulation regions,

wherein when one character sector is first depressed at the second manipulation region or the third manipulation region, the input processing section designates a representative character allocated to the depressed character sector as a current character to cause a code of the designated current character to be transmitted to the main device,

wherein in case where the current character transmitted to the main device is not identical to a character which a user wants to input, when the depressed position of the touch region is shifted to another position within the corresponding manipulation region while maintaining the depressed state of the touch region, the input processing section designates a representative character adjacent to the representative character allocated to the first depressed character sector as the current character, and

wherein when the current character is designated, the input processing section transmits a code of the previously designated current character to the main device along with a code required to cause the display state of the main device to return to an original state in which the previously designated current character was not transmitted to the main device.

Preferably, a manipulation region allocated with the representative character of a character which the user wants to input is depressed, and then the depressed position of the touch region is shifted within the manipulation region while maintaining the depressed state of the touch region to allow the representative character of the character which the user wants to input to be designated as a current character,

when the depressed position of the touch region is shifted to another manipulation region while maintaining the depressed state of the touch region, one of the associated characters of the designated current character is newly designated as a current character and the character sector of the other manipulation region which has been shifted is re-allocated with the associated characters of the designated current character,

if the newly designated current character is not identical to the character which the user wants to input, the depressed position of the touch region is shifted within the shifted manipulation region while maintaining the depressed state of the touch region to allow the representative character of the character which the user wants to input to be designated as a current character, and

when the depressed state of the touch region is released, the character sector of the shifted manipulation region is re-allocated with original representative characters.

In addition, in case where it is desired to change one or all of the input language modes of the second and third manipulation regions, when one of the first, second and third manipulation regions is first depressed and the depressed position of the touch region is shifted to another manipulation region, the input processing section changes the input language mode which a user wants to change and allocates the representative characters of the changed input language mode to the character sector of the manipulation region where the input language mode is changed.

Also, preferably, in case where the depressed position of the touch region is shifted to the other manipulation region, the input language mode is changed and the representative characters of the changed input language mode are allocated to the character sectors of the manipulation region where the input language mode is changed before the depressed state of the touch region is released at the other manipulation region, and one of the representative characters allocated to the character sectors of the other manipulation region is designated as a current character, and

in case where the designated current character is not identical to a character which a user wants to input, when the depressed position of the touch region is shifted to another position at the other manipulation region while maintaining the depressed state of the touch region to cause the character which a user wants to input to be designated as the current character and then the depressed state of the touch region is released, the input language mode of the changed manipulation region is re-changed to an original input language mode and the representative characters of the input language prior to the change of the input language mode are re-allocated to the character sectors of the manipulation region where the input language mode is changed.

Preferably, in case where the character designated as the current character is the control character and performs an independent function assigned to the control character, when the control character is selected and the depressed state of the control character of the touch screen is released, the input processing section allows a code of the current character to be transmitted to the main device,

in case where the character designated as the current character is the control character and is intended to be simultaneously depressed along with another character, when the control character are selected and the depressed state of the control character of the touch screen is released, the input processing section waists for a current character to be inputted subsequently and then sets a control character input state of allowing a code of the subsequently inputted current character to be transmitted to the main device immediately after a code of the control character, and

when a current character for allowing the control character input state to be terminated is selected in the control character input state and the depressed state of the current character of the touch screen is released, the input processing section transmits a code of the current character for allowing the control character input state to be terminated to the main device immediately after a code of the control character set prior to the current character for allowing the control character input state to be terminated and processes the control character input state to be released.

Preferably, in case where the representative characters of the manipulation region include directional keys, when a user depresses a first directional key indicating the direction where the user wants the input position of the main device to be shifted and then releases the depressed state of the touch region, a code of the first direction key is transmitted to the main device, when the depressed position of the touch region is shifted in one direction at the manipulation region where the first directional key exists while maintaining the depressed state of the touch region, the code of the first direction key is repeatedly transmitted to the main device, and when the depressed position of the touch region is shifted in an opposite direction at the manipulation region while maintaining the depressed state of the touch region, the code of a second direction key which is shifted in the opposite direction to that of the first directional key is repeatedly transmitted to the main device.

Further, preferably, the representative characters or the associated characters of the representative characters are sequentially designated as the current character within the manipulation region in an adjacent order according to a degree of shift of the depressed position of the touch region within the manipulation region.

Preferably, the touch type character input device further comprises an input language mode setting section for setting the input language mode or an input language mode display section for displaying the type of the set input language mode.

Preferably, when the depressed state of the touch region is released at the outside of the closed curve of the outermost peripheral manipulation region within the touch region, the current character displayed on the character display section is deleted to cancel the entry of the character.

Also, preferably, the touch region of the outside of the closed curve of the outermost peripheral manipulation region is first depressed, the function of the character input device is not performed over the entire touch region but the intrinsic function of the touch region is implemented.

The touch type character input device of the present invention may be applied to a touch screen in which a screen is positioned behind the touch type character input device. Also, in case of a touch pad having no a screen, a print layer where a manipulation region is displayed or a transparent plate displayed with the manipulation region may be mounted on the touch pad.

The manipulation region of the present invention is defined as one surrounded by a closed curve. The second manipulation region and third manipulation region have a plurality of character sectors each allocated with a corresponding representative character, and a representative character to be transmitted to the main device can be designated a current character through the manipulation of the touch region.

In the following description, as used herein, the phrase “depressing representative characters” is identical to depressing character sectors allocated with representative characters. The phrase “changing representative characters of a manipulation region” means dividing a corresponding manipulation region into character sectors and reallocating new representative characters to the divided character sectors.

As used herein, the term “representative characters” refer to characters allocated to the character sectors within a manipulation region, the term “associated characters” refer to characters associated with the representative characters, and the term “current characters” refer to characters to be transmitted to a main device.

In case of the Korean alphabet (Hangeul), “□”, “□”, “□”, “□”, “□”, “□”, “□”, “□”, “□”, “□”, “□”, “□”, “□”, “□” and “□” can be designated as its representative characters and the associated characters of the representative characters may include all the consonants and vowels except for these representative characters as well as the representative characters.

For example, “□” and “□”, and as “□”, “□”, “□”, “□”, “□”, “□”, etc., may be designated as the associated characters of a representative character “□” by adding characters starting with “□” to the representative character “□” and the associated characters“□” and “□”. Also, “□”, “□” and “□” may be designated as the associated characters of a representative character “□”. Accordingly, the kind of the associated characters may be differently selected according to a designer's needs, and all the consonants and vowels may be designated as the representative characters without any associated characters.

In case of the English alphabet, the lower-case letters or the upper-case letters may be designated as its representative characters, and the associated characters of the representative characters may include the lower-case letters or the upper-case letters, European characters as well as the representative characters.

If “e” is designated as a representative character, “e”, “E”, “Ë” and “□” may be designated as the associated characters of the representative character “e”.

In case of the Japanese alphabet, [symbol] [symbol] [symbol]
and [symbol]
can be designated as its representative characters. For example, [symbol] [symbol] [symbol] [symbol]
and [symbol]
may be designated as the associated characters of a representative character [symbol] [symbol]
and [symbol]
may also be designated as the representative characters according to a designer's needs. For example, [symbol] [symbol] [symbol]
and [symbol]
may be designated as the associated characters of a representative character

[symbol]

In case of the Arabic numeral, “1”, “2”, “3”, “4”, “5”, “6”, “7”, “8”, “9”, “0”, “#” and “*” can be designated as its representative characters, and an input device may be configured without the associated characters. For example, “\textcircled{1}”, “□”, “□”, “I”, etc., may be designated as the associated characters of a representative character “1”.

In case of control characters, characters of special keys such as “sp”, “bs”, “tab”, “ret”, “alt”, “win”, “cap” and “shift” and direction keys can be designated as its representative characters. Also, a combination of multiple control characters may be designated as the representative characters.

In case of the Chinese alphabet, for the Romanization pinyin method allowing a user to input Chinese characters by entering the pinyin (where pin means “spell” and yin means “sound”) of a Chinese character, the English letters are inputted for entry of Chinese characters, and hence the representative characters of the Chinese alphabet are configured in the same way as in the English alphabet. For example, the associated characters of representative characters can be configured in such a manner that “ai”, “ao”, “an” and “ang” are designated as the associated characters of a representative character “a”, “ua”, “uai”, “ui”, “uo”, “uan” and “uang” are designated as the associated characters of a representative character “u”, and “ch”, “sh” and “zh” are designated as the associated characters of a representative character “c”, “s” and “z”, respectively.

In addition, in case of the “Five-Strokes” Chinese input method of using the “five strokes” font or Chinese radicals sorted by the number of strokes to put in a Chinese character or the radical-based Chinese input method, the roots of Chinese characters or the Chinese radicals may constitute representative characters of the Chinese alphabet to designate the associated characters of the representative characters depending on the Chinese character roots or the Chinese radicals.

In the present invention, in case of using a touch screen, the representative characters or associated characters allocated to a manipulation region are displayed on the touch screen to allow the position of a character sector to be grasped, but in case of using a touch pad but not the touch screen, a input character can be displayed on a character display section or a screen of a main device and a current character can be selected while changing a depressing position within the manipulation region, which eliminates the need that the representative characters or associated characters must be displayed on the touch pad or the touch screen.

### BRIEF DESCRIPTION OF THE DRAWINGS

FIG. 1 is a view illustrating a touch screen of a conventional character input device according to the prior art;

FIG. 2 is a view illustrating a touch screen of another conventional character input device according to the prior art;

FIG. 3 is a view illustrating a touch screen of another conventional character input device according to the prior art;

FIGS. 4(a) to 4(d) are views illustrating examples of a manipulation region of a touch type character input device according to the present invention;

FIGS. 5 to 7 are views illustrating examples of the manipulation regions of a touch type character input device according to respective embodiments of the present invention;

FIG. 8 is a top plan view illustrating a mouse to which a touch region is applied according to the present invention; and

FIG. 9 is a view illustrating an example of the manipulation region of a touch type character input device according to one embodiment of the present invention.

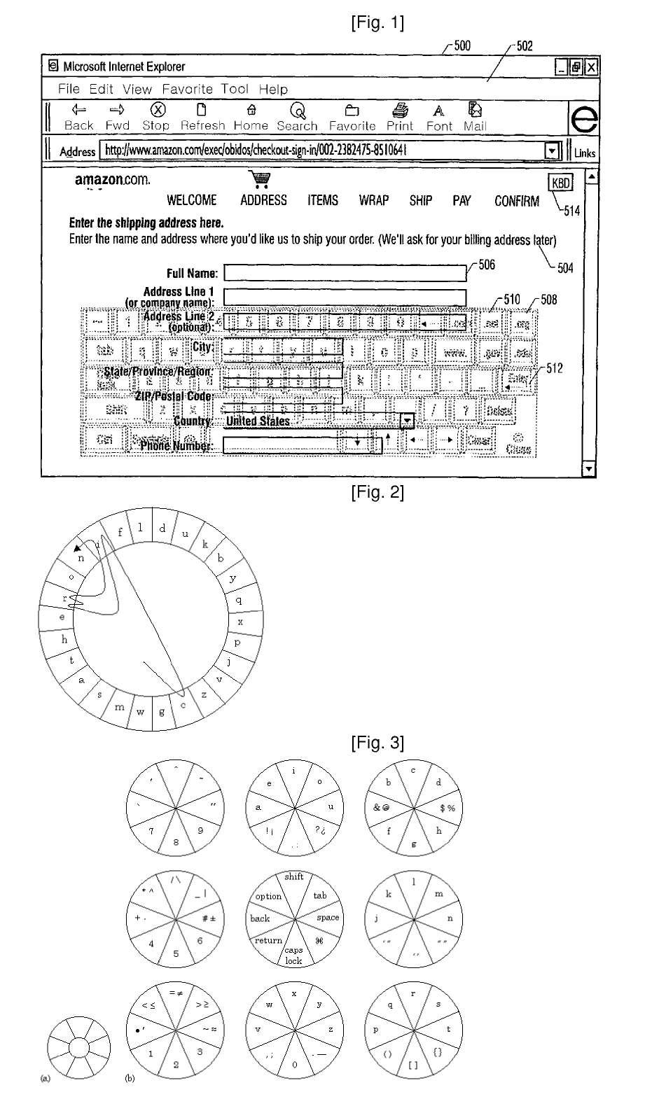

### MODE FOR THE INVENTION

Reference will now be made in detail to inventions described in respective claims according to an embodiment of the present invention with reference to the attached drawings.

The functions of the inventions described in the respective claims can be arbitrarily selected according to a designer' needs to implement the touch type character input device of the present invention and the detailed description of its redundant construction will be omitted.

As used herein, the terms “main device” refers to all kinds of equipment which enables a character to be inputted at an input position on a screen thereof through a touch type character input device such as a touch screen or a touch pad.

While the touch type input device will be described hereinafter with reference to a touch screen, it can be applied to a touch pad. In case where the representative characters cannot be displayed or are changed, its description will be made separately.

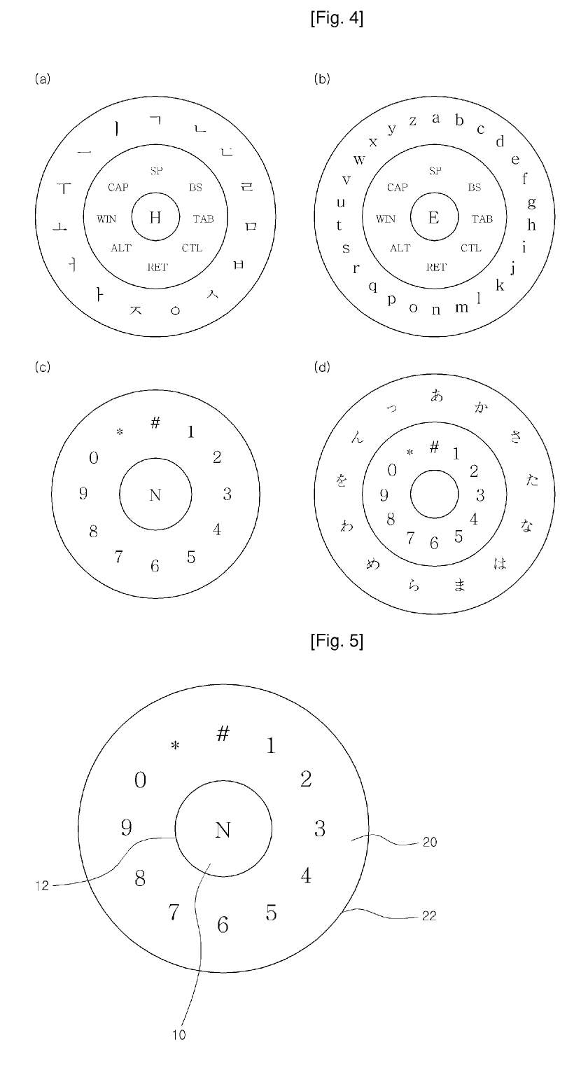

FIGS. 4(a) to 4(d) illustrate examples of character arrangement mode where representative characters are allocated to a second manipulation region or second and third manipulation regions of a touch type character input device according to the present invention, wherein FIG. 4(a) is a view illustrating a character arrangement mode where the Korean characters are arranged in a third manipulation region and control characters are arranged in a second manipulation region, FIG. 4(b) is a view illustrating a character arrangement mode where the English characters are arranged in a third manipulation region and control characters are arranged in a second manipulation region, FIG. 4(c) is a view illustrating a character arrangement mode where Arabic numerals and symbols are arranged in a second manipulation region, and FIG. 4(d) is a view illustrating a character arrangement mode where the Japanese characters are arranged in a third manipulation region and Arabic numerals and symbols are arranged in a second manipulation region.

FIGS. 4(a) to 4(d) merely illustrate the arrangement examples of the representative characters, and the present invention is not limited by selection and arrangement of the representative characters and selection of an input language according to an input language mode.

### Embodiment 1

A first embodiment is directed to the invention of claim 1. The invention of claim 1 discloses a touch type character input method in which when a touch screen is depressed and then the depressed state of the touch region is released or a depressed position is shifted and then the depressed state is released so as to input a character, a corresponding character is transmitted to a main device. The touch type character input method disclosed in claim 1 is different from the conventional selection-based input method in which when a corresponding character on a touch screen is depressed, it is immediately transmitted to a main device. Also, The touch type character input method disclosed in claim 1 is different from the character input methods of the conventional prior arts including the Korean Patent Laid-Open Publication No. 2003-18665 in which it is determined whether or not any gesture occurs in a given time period after depressing a character on the touch screen, in that a character being inputted can be corrected prior to its transmission to the main device.

FIG. 5 is a view illustrating the arrangement of the characters in the manipulation regions of a touch type character input device according to a first embodiment of the present invention.

Referring to FIG. 5, the touch type character input device includes a first manipulation region 10 formed at the central portion of the touch region in such a fashion as to be defined by a first closed curve 12 within the touch region, and a second manipulation region 20 formed at the peripheral portion of the touch region in such a fashion as to be defined by a second closed curve 22 so as to surround the first manipulation region 10 within the touch region. That is, the inside area of the first closed curve 12 is set as the first manipulation region 10 of the touch region, the remaining area other than the first manipulation region 10 among the inside area of the second closed curve 22 surrounding the first manipulation region 10 is set as the second manipulation region 20. The numerals and symbols “1”, “2”, “3”, “4”, “5”, “6”, “7”, “8”, “9”, “0”, “*” and “#” are arranged as representative characters in a second manipulation region 20, each of which is allocated to a corresponding character sector (not shown) defined by dividing the second manipulation region 20.

When a user performs a manipulation action such as depressing the first and second manipulation regions 10 and 20, shifting a depressed position in a depressed state or releasing the depressed state of the touch region, a touch signal is generated in response to the manipulation action. The touch signal includes information on positional coordinates and manipulation action. An input processing section serves to designate a current character, set an input language mode according to the touch signal, or change the position of a cursor.

In case where a touch region is installed at a separate auxiliary device disposed spaced apart from the main device, the input processing section of the present invention may be positioned at the separate auxiliary device or the main device. In case where the main device includes a touch region, of course, the input processing section is disposed at the main device.

The current character designated by the input processing section is displayed on a character display section. In an embodiment of the present invention corresponding to the case of using the character display section, in case of a touch screen, the current character can be, of course, displayed on the screen. In case of a touch pad, the current character can be, of course, displayed at the outside of the touch pad using an LED or LCD by which characters can be displayed. In addition, an LED or LCD may be disposed in a certain region inside of the touch pad so as to display the current character. Those skilled in the art will easily appreciate that this character display section could be disposed on a screen of the main device.

A character input mode in which a first embodiment of the present invention is performed will be described hereinafter.

The case where a user inputs a character “1” will be described as an example of Embodiment 1.

As shown in FIG. 5, “1”, “2”, “3”, “4”, “5”, “6”, “7”, “8”, “9”, “0”, “*” and “#” are displayed as representative characters in a second manipulation region of a touch screen.

When a user first depresses a representative character “1” displayed in the second manipulation region, the representative character “1” allocated to the depressed character sector is displayed on the character display section. At this time, when the depressed state of the character sector is released, a code corresponding to a current character “1” displayed on the character display section is transmitted to the main device.

On the other hand, when the user erroneously depresses the representative character to cause a representative character “2” to be displayed as a current character on the character display section, if he or she shifts a depressed position to the representative character “1” at a state where the representative character “2” is depressed, the current character “2” displayed on the character display section is changed into “1”. At this time, when it is determined that the current character displayed on the character display section is “1”, the user releases the depressed state of the character sector allocated with the current character “1” so as to allow a code corresponding to the current character “1” to be transmitted to the main device.

The conventional prior art is intended such that a depressed position is shifted to a character sector allocated with a character which a user wants to input, whereas this embodiment is intended such that when a user shifts a depressed position by a given distance designated by a designer, a character can be changed although the shifted depressed position does not exist within a character sector allocated with a character which the user wants to input.

The main device receives the code of the current character and displays the current character based on the received code.

The user can input a character which he or she wants to input through the above character input process.

Such operation in the first embodiment is accomplished by the input processing section which processes a touch signal generated in the manipulation region. Those skilled in the art will easily appreciate that the above operation is implemented on a software basis through a coordinate signal generated in the manipulation region.

Besides, in the present invention, the character display section may display a current character using sound and is also not limited to displaying the current character visually.

Those skilled in the art can easily realize, based on a conventional technology which recognizes a character visually or audibly, that the current character is displayed visually/audibly through the character display section.

In addition, the shape of a closed curve in the present invention is not limited to a circular one, but includes the shape of an oval, polygon, etc.

### Embodiment 2

A second embodiment 2 is directed to the invention of claim 1.

The second embodiment is different from the first embodiment in that it is possible to input a character without including the character display section.

The operation of the second embodiment will also be described hereinafter with reference to FIG. 5.

First, the case where a user inputs a character “12” will be described as an example of the second embodiment.

When a user first depresses a character sector allocated with “1” in the second manipulation region, a representative character corresponding to the depressed position of the character sector is transmitted to the main device so that the representative character is displayed at an input position of a screen of the main device screen. Then, the user releases the depressed state of the character sector and then proceeds to a step of selecting “2”.

However, in this case, if the user erroneously depresses “#” but not “1” to cause “#” to be displayed at the input position of the screen of the main device, it is required that the user should shift the depressed position of the touch region to “1” while maintaining the depressed state of the touch region to cause “1” to be displayed on the screen of the main device. But since “#” has been already transmitted to the main device, “#” displayed on the screen of the main device needs to be deleted and a new character “1” needs to be transmitted to the main device to cause the display state of the main device to return to a previous state in which “#” was not transmitted to the main device. Thus, the depressed position of the touch region is shifted so as to allow a code of “#” to be transmitted to the main device along with a backspace code. By doing so, “#” is deleted by means of the backspace code and hence “1” is displayed on the screen of the main device screen.

In the above method, subsequently, when the user transmits “2” to the main device, the main device receives a code of “2” to cause a character “2” to be displayed at the input position of the main device screen.

### Embodiment 3

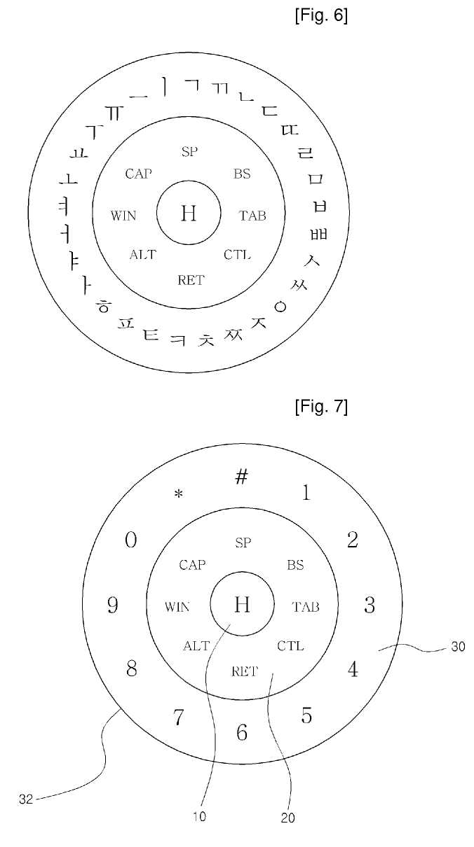

A third embodiment is directed to the inventions of claims 3 and 4. The operation of the third embodiment will be described hereinafter with reference to FIG. 6.

FIG. 6 is a view showing a touch region where English lower-case letters are arranged as representative characters at the second manipulation region. In this third embodiment, only English upper-case letters are designated as the associated characters of the representative characters.

A character input method in this third embodiment will be described in the same method as in the first embodiment, but may be, of course, described in the same method as in the second embodiment.

The case where a user inputs a character “At” will be described as an example of the third embodiment.

Similarly to the first embodiment, a user allows “a” arranged on the second manipulation region to be displayed as a current character on the character display section and then shifts the depressed position of the touch region to the first manipulation region while maintaining the depressed state of the touch region to cause the current character “a” displayed on the character display section to be changed to “A”. When the user releases the depressed state of the current character “A” displayed on the character display section, a code of the current character “A” is transmitted to the main device to cause the current character “A” to be displayed on the input position of the main device.

In addition, similarly to the first embodiment, the user allows “a” arranged on the second manipulation region to be displayed as a current character on the character display section and then shifts the depressed position of the touch region to the first manipulation region and re-shifts it to the second manipulation region while maintaining the depressed state of the touch region to cause the current character “a” displayed on the character display section to be changed to “A”. When the user releases the depressed state of the current character “A” displayed on the character display section, a code of the current character “A” is transmitted to the main device to cause the current character “A” to be displayed on the input position of the main device.

### Embodiment 4

A fourth embodiment is directed to the invention of claim 5. The operation of the fourth embodiment will also be described hereinafter with reference to FIG. 6.

As shown in FIG. 6, for example, English lower-case letters are arranged as representative characters at the second manipulation region within the touch region, and English upper-case letters, English letters put in parentheses and English letters put circles are designated as the associated characters of the representative characters.

A character input method in this fourth embodiment will be described in the same method as in the first embodiment, but may be, of course, described in the same method as in the second embodiment.

When a user wants to input “□”, he or she first selects “a” as a representative character in the same method as in the first embodiment and then shifts the depressed position of the touch region to the first manipulation region and re-shifts it to the second manipulation region while maintaining the depressed state of the touch region. Then, the associated characters “A” “□” and “□” of the representative character “a” prior to the shifting of the depressed position of the touch region to the first manipulation region are allocated to the divided character sectors of the second manipulation region to cause a corresponding one of the associated characters of the selected representative character to be designated as a current character so as to be displayed on the character display section.

If “□” is displayed as the current character on character display section, the user releases the depressed state of the touch region to allow a code of “□” to be transmitted to the main device.

On the other hand, if “A” is displayed as the current character on the character display section, the user repeatedly changes the depressed position at the second manipulation region until “□” is displayed on the character display section to cause “□” to be designated as the current character.

At this time, if the depressed state of the touch region is released, the representative characters of the second manipulation region are again allocated to the character sectors of the second manipulation region so as to allow the representative characters of the second manipulation region to be inputted.

### Embodiment 5

A fifth embodiment is directed to the invention of claim 4 disclosing the change of an input language mode. The operation of the third embodiment will be described hereinafter with reference to FIG. 6. In the fifth embodiment, the case where two input language modes including a numeral input mode and an English alphabet input mode will be described hereinafter.

First, as shown in FIG. 6, in order to input a numeral while an English letter is inputted in an English alphabet input mode, it is required to change the input mode. In this case, when a user depresses the first manipulation region and shifts the depressed position of the touch region to the second manipulation region while maintaining the depressed state of the touch region, the representative characters of the changed input language are allocated to the character sectors of the second manipulation region.

In the process of inputting a numeral in a numeral input mode after the input language mode is changed into the numeral input mode, in order to re-change the input language mode from the numeral input mode to the English alphabet input mode, it is required that the user re-depresses the first manipulation region and shifts the depressed position of the touch region to the second manipulation region while maintaining the depressed state of the touch region. Then, the input language mode can be re-changed from the numeral input mode to the English alphabet input mode.

Although two input language modes has been described in the fifth embodiment, it is also possible to set multiple input language modes including a Hangeul input mode, an English alphabet input mode, a numeral input mode, a symbol input mode and a control input mode, and repeatedly perform a process of depressing the first manipulation region and then shifting the depressed position of the touch region to the second manipulation region while maintaining the depressed state of the touch region so as to sequentially change the input language mode.

### Embodiment 6

A sixth embodiment is directed to the invention of claim 4 disclosing the temporary change of the input language mode.

If it is desired to input a numeral “1” and then re-input an English letter in the process of inputting an English letter, the following operation can be performed.

First, a user depresses the first manipulation region and shifts the depressed position of the touch region to the second manipulation region while maintaining the depressed state of the touch region to change the input language mode. Then, the representative characters of the newly changed input language are allocated to the character sectors of the second manipulation region according to the changed input language mode and displayed at the second manipulation region of the touch screen. At this time, in the same operation as that in the first embodiment, a character “1” which the user wants to input is designated as a current character to allow a code of the current character “1” to be transmitted to the main device. Also, when the depressed state of the touch region is released, the input language mode is re-changed to an original input language mode to allow the representative characters of the input language prior to the change of the input language mode to be allocated to the character sectors of the second manipulation region. Thus, in this manner, the input language mode can be changed temporarily.

### Embodiment 7

A seventh embodiment is directed to the invention of claims 8 and 9. The invention of the seventh embodiment is different from the first and second embodiments in that the touch region on the touch screen further includes a third manipulation region 30 formed at the peripheral portion of the touch region in such a fashion as to be defined by a third closed curve so as to surround the second manipulation region within the touch region.

In the seventh embodiment, for example, the control characters are allocated to the character sectors of the second manipulation region as the representative characters, and the Korean characters are allocated to the character sectors of the third manipulation region as the representative characters. In terms of the process in which the current characters are designated in the respective manipulation regions where the representative characters are disposed and then corresponding codes of the designated current characters are transmitted to main device, the invention of claim 1 is identical to that of claim 8 and the invention of claim 2 is identical to that of claim 9.

In the seventh embodiment of the present invention, reference will be made hereinafter in detail to the inventive input character correction method disclosed in inventions described in the independent claims 2 and 9 and dependent claims of the independent claims 2 and 9 in case where the Hangeul, i.e., the Korean alphabet is designated as the representative character.

Such an input character correction method can be used in the Chinese character input method in which the Chinese characters are inputted through the combination of the roots of Chinese characters and Chinese radicals.

In case where it is desired to input a Korean character “□”, a user first allows “□” to be displayed at the input position of the main device screen, and subsequently depresses the manipulation regions or shifts the depressed position of the touch region to cause Korean characters “□”, “□” and “□” to be displayed on the main device screen in this order, which is the same as described in the second embodiment.

When a trailing consonant “□” of the Korean character “□” is erroneously inputted as “□” to form an erroneous character “□□”, the erroneously inputted consonant is corrected, which will be described hereinafter.

In this case, in order to correct the erroneously inputted consonant, a control character “BS” (backspace) of the second manipulation region is typically depressed two times to delete “□” and “□”, and then “□”, “□”, “□” and “□” are inputted in this order to form a complete character “□”. In this case, the input processing section can automatically memorize a character which has been inputted previously so as to automatically perform the input character correction method.

For example, in case where the erroneous character “□□” is displayed on the main device screen, the input processing section can recognize that the character “□” is composed of a leading consonant “□” as the initial sound (choseong), a vowel “□” as the medial sound (jungseong) and a trailing consonant “□” as the final sound (jongseong). When the leading consonant “□” is designated as a current character in the same method as disclosed in claim 2 or 9, it is possible allow the input processing section to transmit a code of the current character “□” along with a code of “BS”(backspace)-“BS”(backspace)-“□”-“□”-“□” to the main device to delete the erroneous character “□□” to thereby form the complete character “□”.

In terms of the properties of the Hangeul alphabet, since a vowel is designed to follow a consonant, in case where a user attempts to input “□□”, when “□” is designated again in the above manner although “□□” has been inputted, the input processing section transmits a code of the designated character “□” along with a code of “BS”(backspace)-“BS”(backspace)-“□”-“□”-“□” to the main device to delete the erroneous character “□□” to thereby display the character “□” on the screen of the main device. Then, when a code of “□” is transmitted to the main device, the desired character “□□” can be displayed on the main device screen.

Therefore, “a code required to cause the display state of the main device to return to an original state in which the previously designated current character was not transmitted to the main device” in the inventions of claims 2 and 9 may be a “backspace” code or a combined code of “BS”(backspace)-“BS”(backspace)-arrangement of consonants and vowels composing the previous character“.

### Embodiment 8

An eighth embodiment is directed to the invention of claim 10. As shown in FIG. 4(a), in the eighth embodiment, for example, the control characters are allocated to the character sectors of the second manipulation region as the representative characters, and the Korean characters are allocated to the character sectors of the third manipulation region as the representative characters.

In the eighth embodiment, the character input method is performed in the same manner as in the inventions of claims 1 and 8, but may be, of course, performed in the same manner as in the inventions of claims 2 and 9.

The case where a user inputs a Korean character “□” will be described hereinafter.

In order to input “□”, the user first allows the input processing section to designate the representative character “□” of “□” as a current character in the third manipulation region to cause the designated current character “□” to be displayed on the character display section, and then shifts the depressed position of the touch region to the second manipulation region while maintaining the depressed state of the touch region.

Then, in place of the control characters of the second manipulation region, the associated characters “□”, “□” and “□” of the designated current character “□” are reallocated to the character sectors of the second manipulation region as the representative characters, one of “□”, “□” and “□” is displayed on the character display section. If “□” is displayed on the character display section, the user releases the depressed state of the touch region to allow a code of “□” to be transmitted to the main device. On the other hand, if “□” displayed on character display section, since the character sector of the second manipulation region has been re-allocated with the associated characters of “□”, the user shifts the depressed position of the touch region within the second manipulation region to allow “□” to be displayed as the current character on the character display section while passing by “□”, and then releases the depressed state of the touch region to allow a code of “□” to be transmitted to the main device. At this time, when the depressed position of the touch region is released within the second manipulation region, the control characters are re-allocated as the original representative characters to the character sector of the second manipulation region.

Similarly, in order to input “□”, the user first allows the input processing section to designate the representative character “□” of “□” as a current character in the third manipulation region to cause the designated current character “□” to be displayed on the character display section, and then shifts the depressed position of the touch region to the second manipulation region while maintaining the depressed state of the touch region to allow the associated character “□” of “□” to be displayed on the character display section. Then, when the user releases the depressed state of the touch region, the control characters are re-allocated as the original representative characters to the character sector of the second manipulation region.

If “□” and “□” are continuously inputted and the main device can recognize this as “□”, the associated characters of “□” will be able to be designated as “□” and “□”.

At this time, when the depressed position of the touch region is shifted from the third manipulation region to the second manipulation region, “□” may be designated as the current character. Also, when the depressed position of the touch region is shifted from the second manipulation region to the first manipulation region, “□” may be designated as the current character.

### Embodiment 9

A ninth embodiment is directed to the invention of claim 11. As shown in FIG. 7, in the ninth embodiment, for example, the control characters are allocated to the character sectors of the second manipulation region as the representative characters, and the Korean characters are allocated to the character sectors of the third manipulation region as the representative characters.

In case where it is desired to change one or all of the input language modes of the second and third manipulation regions, when one of the first, second and third manipulation regions is first depressed and the depressed position of the touch region is shifted to another manipulation region, the input language mode may be changed and the representative characters of the changed input language mode may be allocated to the character sector of the manipulation region where the input language mode is changed.

The eighth embodiment shows case where if any manipulation region is changed, the associated characters of the changed manipulation region is displayed, but the ninth embodiment shows the case where the input language mode is changed. These embodiments are merely examples of the present invention. Those skilled in the art will be able to select whether or not the change of the manipulation region will cause the change of the input language mode or the associated characters the designated current character will be allocated to the character sector according to the input language arranged in the second manipulation region and the third manipulation region so as to easily reconstruct the input language mode.

### Embodiment 10

The tenth embodiment is directed to the invention of claim 12 disclosing the temporary change of the input language mode as disclosed in the sixth embodiment.

In case where the depressed position of the touch region is shifted to the other manipulation region, the input language mode is changed and the representative characters of the changed input language mode are allocated to the character sectors of the manipulation region where the input language mode is changed before the depressed state of the touch region is released at the other manipulation region, and one of the representative characters allocated to the character sectors of the other manipulation region is designated as a current character. On the other hand, in case where the designated current character is not identical to a character which a user wants to input, when the depressed position of the touch region is shifted to another position at the other manipulation region while maintaining the depressed state of the touch region to cause the character which a user wants to input to be designated as the current character and then the depressed state of the touch region is released, the input language mode of the changed manipulation region is re-changed to an original input language mode and the representative characters of the input language prior to the change of the input language mode are re-allocated to the character sectors of the manipulation region where the input language mode is changed.

### Embodiment 11

The eleventh embodiment is directed to the invention of claim 13 disclosing the case where the representative characters of the second manipulation region are composed of the control characters as shown in FIGS. 4(a) and 4(b). The representative characters of the third manipulation region may be, of course, composed of the control characters.

The control characters such as BS(backspace), RET(enter), sp(space), tab and CAP independently function to delete a preceding character, change an input line, enter the space between the words, change the input position to the position of a designated tab and allow all the to-be-inputted characters to be entered as upper-case letters, respectively.

Therefore, these control characters can be transmitted to the main device in the same manner as in the case where characters of other input languages are transmitted to the main device.

On the other hand, the control characters such as CTL(control), ALT and WIN perform corresponding designated functions by means of characters simultaneously depressed along therewith, respectively. Thus, when a user selects a corresponding control character and releases the depressed state of the corresponding control character of the touch screen, the input processing section waists for a current character to be inputted subsequently and then sets a control character input state of allowing a code of the subsequently inputted current character to be transmitted to the main device immediately after a code of the control character.

When a current character for allowing the control character input state to be terminated is selected in the control character input state and the depressed state of the current character of the touch screen is released, the input processing section transmits a code of the current character for allowing the control character input state to be terminated to the main device immediately after a code of the control character set prior to the current character for allowing the control character input state to be terminated and processes the control character input state to be released.

That is, in case where the control character CTL is intended to be depressed along with the control characters ALT and DEL such as CTL-ALT-DEL, CTL characters, the control character ALT following the control character CTL cannot be the current character for allowing the control character input state to be terminated, and subsequently the character for allowing the control character input state to be terminated such as the control character DEL must be inputted for transmission to the main device. Thereafter, such a control character input state is released.

### Embodiment 12

The twelfth embodiment is directed to the invention of claim 14 disclosing the case where the representative characters of the manipulation region include directional keys such as Up, Down, Left and Right directional keys, Page Up/Down directional keys.

In case where a user wants to shift the input position of the main device to the left, he or she depresses a left directional key (a first directional key) indicating the direction where the user wants the input position of the main device to be shifted and then releases the depressed state of the touch region to cause a code of the first direction key to be transmitted to the main device. When the depressed position of the touch region is shifted in a counterclockwise direction at the manipulation region where the first directional key exists while maintaining the depressed state of the touch region, the code of the first direction key is repeatedly transmitted to the main device, and when the depressed position of the touch region is shifted in a clockwise direction at the manipulation region while maintaining the depressed state of the touch region, the code of a right directional key (second direction key) which is shifted in the opposite direction to that of the first directional key is repeatedly transmitted to the main device. In case where these directional keys are allocated to the character sectors of the manipulation region, if there are exist only Up, Down, Left and Right directional keys in the character sectors, the manipulation region is divided into four character sectors. If there are additionally included Page Up/Down directional keys in the character sectors, the manipulation region is divided into eight character sectors. Thus, there is a few possibility of erroneously selecting the depressed position of the touch region and it is very convenient to use the directional keys.

### Embodiment 13

The present invention enable a user to input a character which he or she wants to input although the representative characters are not displayed on the manipulation region.

The thirteenth embodiment of the present invention is directed to the invention of claim 15 disclosing the case of allowing a representative character to be sequentially designated as a current character within the manipulation region in an adjacent order according to the shift of the depressed position of the touch region regardless of whether or not the representative characters are displayed on the manipulation region.

That is, while has been described an example where a user can input a character although the representative characters are not displayed on a touch pad, it is of course possible to apply the thirteenth embodiment to a touch pad or a touch screen having representative characters displayed thereon.

For example, in FIG. 5, in case where numerals are not displayed, but only the first closed curve 12 and the second closed curve 22 are displayed on the touch region, when the user first depresses the second manipulation region 20, a representative character allocated to the character sector of the depressed second manipulation region is displayed on the character display section as a current character. In case of the touch screen, the representative characters are displayed on the screen to allow the representative characters to be depressed. But in case of the touch pad having no characters displayed thereon, an arbitrary position on the second manipulation region must be depressed. The user continues to shift the depressed position of the touch region until a representative character allocated to a corresponding character sector of the depressed second manipulation region is displayed as “1” while watching characters displayed being on the character display section. Namely, when “9” is displayed on the character display section by first depressing the second manipulation region, the user continuously shifts the depressed position of the touch region within the second manipulation region while maintaining the depressed state of the touch region. Then, “0”, “*”, “#” and “1” are displayed on the character display section in this order depending on a degree of shift of the depressed position of the touch region. When “1” is displayed on the character display section, the user releases the depressed state of the touch region to allow a code of “1” as a current character displayed on the character display section to be transmitted to the main device. Since the current characters displayed on the character display section are changed depending on a degree of shift of the depressed position of the touch region, the depressed position of the touch region do not need to be accurately shifted to a character sector allocated with a character which the user wants to input as a representative character.

Therefore, the representative characters of the present invention are not limited to those being displayed viewably within the manipulation regions.

In case of the touch screen, the intervals between respective representative characters are densely set, and hence a user may not accurately depress a representative character which he or she wants to input. Even in this case, the user selects the character which he or she wants to input while shifting the depressed position of the touch region within the second manipulation region so as to transmit a code of the selected character to the main device.

### Embodiment 14

The fourteenth embodiment of the present invention is directed to the invention of claim 16 disclosing an input language mode setting section for setting the input language mode or an input language mode display section for displaying the type of the set input language mode.

In case of the touch pad, it is possible to separately provide a separate on/off switch for allowing the input language mode to be set or a touch region at the inside or the outside of the touch pad so as to set the input language mode. In case of the touch screen, it is possible to provide a touch region for setting the input language mode at a part of a screen region in a touch type, or attach a separate on/off switch to the outside of the screen so as to set the input language mode.

In addition, the touch pad may enable an LED or LCD to be installed at the inside or outside thereof so as to display a current input language mode. Also, the touch screen may enable the input language mode to be displayed at a part of a screen region or enable a separate LED or LCD to be installed at the outside thereof so as to display the input language mode.

### Embodiment 15

The fifteenth embodiment of the present invention is directed to the invention of claim 17 in which in case where it is desired to input characters through the manipulation region, when a user determines that the first depressed position of the touch region is erroneous and shifts the depressed position to the outside of the closed curve of the outermost peripheral manipulation region, the current character is deleted to cancel the entry of the character.

This function enables the depressed position of the touch region to be shifted to the outside of the outermost peripheral manipulation region to cancel the entry of the character in the inventions of claims 1 and 8 in which when he or she releases the depressed state of the touch region to allow a code of the current character displayed on the character display section to be transmitted to the main device at the time of starting to depress the touch region.

In the inventions of claims 2 and 9, when the depressed position of the touch region is shifted to the outside of the outermost peripheral manipulation region, a code of the backspace is transmitted to the main device to cancel the entry of the current character displayed on the character display section.

### Embodiment 16

The sixteenth embodiment of the present invention is directed to the invention of claim 18 in which in case where the touch region of the outside of the closed curve of the outermost peripheral manipulation region is first depressed, the function of the character input device is not performed over the entire touch region but the intrinsic function of the touch region is implemented.

The touch pad or the touch screen has an intrinsic function of allowing a user to shift or click at the position of a cursor. Thus, in order to allow the intrinsic function besides a character input function to be performed, it is preferable to allow the function of the character input device to be not performed and the intrinsic function of the touch pad or the touch screen to be smoothly performed although the depressed position of the touch region is shifted to the inside of the manipulation region to move the cursor when the touch region of the outside of the closed curve of the outermost peripheral manipulation region is first depressed.

### Embodiment 17

In the seventeenth embodiment of the present invention, the whole of a part of the closed curve indicating a boundary line of each manipulation region may be not displayed ion the touch region.

As shown in FIG. 9, in the seventeenth embodiment, the representative characters of the third manipulation region and the second manipulation region are displayed on the touch region in such a manner as to be discernibly arranged on the touch region. The closed curve indicated by a dotted line is merely used as a boundary of each manipulation region and may not be seen with naked eyes. In case where the representative characters are displayed on the touch region, since the user can recognize the width of the character sectors allocated with the representative characters or the manipulation region in a size of the representative character, it is possible to input or correct characters although the closed curve is not displayed on the touch region.

Therefore, the first, second and third closed curves of the present invention are not limited to those being displayed viewably within the manipulation regions.

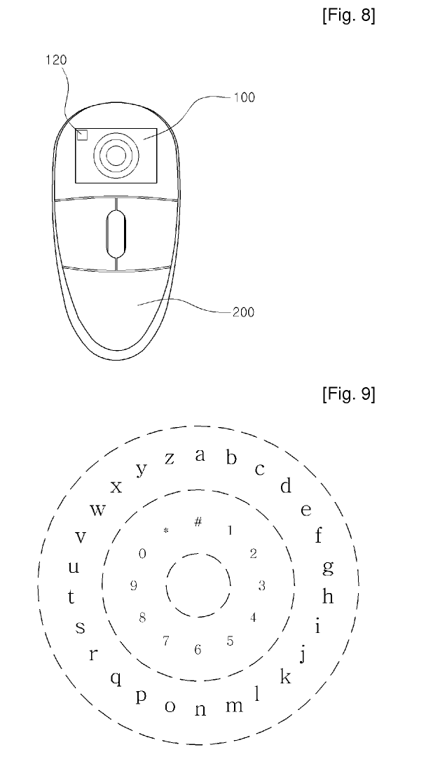

As shown in FIG. 8, the present invention can be implemented such that touch region 100 of the touch type character input device is mounted on the top surface of the mouse 200, and the character display section 120 is provided within the touch region 100 in various forms such as, for example, an LED or LCD.

In addition, a designer will be able to select each function of the embodiments according to his needs to implement the inventive touch type character input device. The functions of the embodiments will be able to be easily implemented by those skilled in the art through the design of the input processing section.

The arrangement of the representative characters and designation of the associated characters are not limited to the embodiments and drawings of the present invention, but may be modified for use according to a designer's needs or be designated such that the number of the designated manipulation regions is more than four within the scope of the technical spirit of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, according to the touch type character input device the present invention, when a user did not accurately depress a character that he or she wants to input, such a depressing error can be corrected easily and simply. In addition, the invention enables a user to select a representative character and then input the associated characters of the representative character so that various characters can be entered using only a small area on the touch screen. Moreover, since correction to the erroneous input is made easily, entry of the character is possible with only a user's finger even without using a stylus pen.

1. A touch type character input device having a touch region where a coordinate is designated or a character is selected using a finger or a tool so as to input the character or the coordinate to a main device, the touch type character input device comprising:
a first manipulation region formed at the central portion of the touch region in such a fashion as to be defined by a first closed curve within the touch region;
a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character;
an input processing section adapted to designate a current character, set an input language mode, or change the position of a cursor in response to a touch signal generated in the first and second manipulation regions; and
a character display section adapted to display the current character designated by the input processing section thereon,
wherein when one character sector is first depressed at the second manipulation region, the input processing section designates a representative character allocated to the depressed character sector as a current character to cause the designated current character to be displayed on the character display section,
wherein in case where the current character displayed on the character display section is not identical to a character which a user wants to input, when the depressed position of the touch region is shifted to another position at the second manipulation region while maintaining the depressed state of the touch region, the input processing section designates a representative character adjacent to the representative character allocated to the first depressed character sector as the current character, and
wherein when the depressed state of the touch region is released within the second manipulation region, the input processing section transmits a code of a finally designated current character to the main device.

2. A touch type character input device having a touch region where a coordinate is designated or a character is selected using a finger or a tool so as to input the character or the coordinate to a main device, the touch type character input device comprising:
a first manipulation region formed at the central portion of the touch region in such a fashion as to be defined by a first closed curve within the touch region;
a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character; and
an input processing section adapted to designate a current character, set an input language mode, or change the position of a cursor in response to a touch signal generated in the first and second manipulation regions,
wherein when one character sector is first depressed at the second manipulation region, the input processing section designates a representative character allocated to the depressed character sector as a current character to cause a code of the designated current character to be transmitted to the main device,
wherein in case where the current character transmitted to the main device is not identical to a character which a user wants to input, when the depressed position of the touch region is shifted to another position at the second manipulation region while maintaining the depressed state of the touch region, the input processing section designates a representative character adjacent to the representative character allocated to the first depressed character sector as the current character, and
wherein when the current character is designated, the input processing section transmits a code of the previously designated current character to the main device along with a code required to cause the display state of the main device to return to an original state in which the previously designated current character was not transmitted to the main device.

3. The touch type character input device according to claim 1, wherein in case where the number of the associated characters of a selected representative character is one, the selected representative character positioned at the second manipulation region is designated as a current character and then the depressed position of the touch region is shifted to the first manipulation region while maintaining the depressed state of the touch region to cause the associated character of the selected representative character to be designated as a current character.

4. The touch type character input device according to claim 1, wherein in case where the number of the associated characters of a selected representative character is one, the selected representative character positioned at the second manipulation region is designated as a current character and then the depressed position of the touch region is shifted to the first manipulation region and re- shifted to the second manipulation region while maintaining the depressed state of the touch region to cause the associated character of the selected representative character to be designated as a current character.

5. The touch type character input device according to claim 1, wherein in case where the number of the associated characters of a selected representative character is plural, the selected representative character positioned at the second manipulation region is designated as a current character and then the depressed position of the touch region is shifted to the first manipulation region and re-shifted to the second manipulation region while maintaining the depressed state of the touch region, so that the associated characters of the selected representative character prior to the shifting of the depressed position of the touch region to the first manipulation region are allocated to the divided character sectors of the second manipulation region to cause a corresponding one of the associated characters of the selected representative character to be designated as a current character so as to be displayed on the character display section,
wherein if the current character displayed on the character display section is not identical to a character which the use wants to input, the user repeatedly shifts the depressed position at the second manipulation region while maintaining the depressed state of the touch region until the character which the user wants to input is displayed on the character display section to cause a corresponding one of the associated characters of the selected representative character to be designated as the current character, and
wherein if the depressed state of the touch region is released, the representative characters of the second manipulation region are again allocated to the character sectors of the second manipulation region.

6. The touch type character input device according to claim 1, wherein when the first manipulation region is first depressed and the depressed position of the touch region is shifted to the second manipulation region while maintaining the depressed state of the touch region, the input language mode is changed to allow the representative characters of the changed input language to be allocated to the character sectors of the second manipulation region.

7. The touch type character input device according to claim 6, wherein the input language mode is changed before the depressed state of the touch region is released at the second manipulation region, and the representative characters of the changed input language are allocated to the character sectors of the second manipulation region to allow one of the representative characters of the changed input language to be designated an a current character, and
wherein if the designated current character is not identical to a character which the user wants to input, the depressed position of the touch region is shifted at the second manipulation region while maintaining the depressed state of the touch region to allow the character which the user wants to input is designated as the current character, and when the depressed state of the touch region is released, the input language mode is re-changed to an original input language mode to allow the representative characters of the input language prior to the change of the input language mode to be allocated to the character sectors of the second manipulation region.

8. A touch type character input device having a touch region where a coordinate is designated or a character is selected using a finger or a tool so as to input the character or the coordinate to a main device, the touch type character input device comprising:
a first manipulation region formed at the central portion of the touch region in such a fashion as to be defined by a first closed curve within the touch region;
a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character;
a third manipulation region formed at the peripheral portion of the touch region in such a fashion as to be defined by a third closed curve so as to surround the second manipulation region within the touch region, the third manipulation region being the remaining area other than the first and second manipulation regions among the area surrounded by the third closed curve and consisting of a plurality of character sectors each allocated with a corresponding representative character of an input language different from the representative characters allocated to the character sectors of the second manipulation region;
an input processing section adapted to designate a current character, set an input language mode, or change the position of a cursor in response to a touch signal generated in the manipulation regions; and
a character display section adapted to display the current character designated by the input processing section thereon,
wherein when one character sector is first depressed at the second manipulation region or the third manipulation region, the input processing section designates a representative character allocated to the depressed character sector as a current character to cause the designated current character to be displayed on the character display section,
wherein in case where the current character displayed on the character display section is not identical to a character which a user wants to input, when the depressed position of the touch region is shifted to another position within the corresponding manipulation region while maintaining the depressed state of the touch region, the input processing section designates a representative character adjacent to the representative character allocated to the first depressed character sector as the current character, and
wherein when the depressed state of the touch region is released within the corresponding manipulation region, the input processing section transmits a code of a finally designated current character to the main device.

9. A touch type character input device having a touch region where a coordinate is designated or a character is selected using a finger or a tool so as to input the character or the coordinate to a main device, the touch type character input device comprising:
a first manipulation region formed at the central portion of the touch region in such a fashion as to be defined by a first closed curve within the touch region;
a second manipulation region formed at the peripheral portion of the touch region in such a fashion as to be defined by a second closed curve so as to surround the first manipulation region within the touch region, the second manipulation region being the remaining area other than the first manipulation region among the area surrounded by the second closed curve and consisting of a plurality of character sectors each allocated with a corresponding representative character;
a third manipulation region formed at the peripheral portion of the touch region in such a fashion as to be defined by a third closed curve so as to surround the second manipulation region within the touch region, the third manipulation region being the remaining area other than the first and second manipulation regions among the area surrounded by the third closed curve and consisting of a plurality of character sectors each allocated with a corresponding representative character of an input language different from the representative characters allocated to the character sectors of the second manipulation region; and an input processing section adapted to designate a current character, set an input language mode, or change the position of a cursor in response to a touch signal generated in the manipulation regions,
wherein when one character sector is first depressed at the second manipulation region or the third manipulation region, the input processing section designates a representative character allocated to the depressed character sector as a current character to cause a code of the designated current character to be transmitted to the main device,
wherein in case where the current character transmitted to the main device is not identical to a character which a user wants to input, when the depressed position of the touch region is shifted to another position within the corresponding manipulation region while maintaining the depressed state of the touch region, the input processing section designates a representative character adjacent to the representative character allocated to the first depressed character sector as the current character, and
wherein when the current character is designated, the input processing section transmits a code of the previously designated current character to the main device along with a code required to cause the display state of the main device to return to an original state in which the previously designated current character was not transmitted to the main device.

10. The touch type character input device according to claim 8, wherein a manipulation region allocated with the representative character of a character which the user wants to input is depressed, and then the depressed position of the touch region is shifted within the manipulation region while maintaining the depressed state of the touch region to allow the representative character of the character which the user wants to input to be designated as a current character,
wherein when the depressed position of the touch region is shifted to another manipulation region while maintaining the depressed state of the touch region, one of the associated characters of the designated current character is newly designated as a current character and the character sector of the other manipulation region which has been shifted is re-allocated with the associated characters of the designated current character,
wherein if the newly designated current character is not identical to the character which the user wants to input, the depressed position of the touch region is shifted within the shifted manipulation region while maintaining the depressed state of the touch region to allow the representative character of the character which the user wants to input to be designated as a current character, and
wherein when the depressed state of the touch region is released, the character sector of the shifted manipulation region is re-allocated with original representative characters.

11. The touch type character input device according to claim 8, wherein in case where it is desired to change one or all of the input language modes of the second and third manipulation regions, when one of the first, second and third manipulation regions is first depressed and the depressed position of the touch region is shifted to another manipulation region, the input processing section changes the input language mode which a user wants to change and allocates the representative characters of the changed input language mode to the character sector of the manipulation region where the input language mode is changed.

12. The touch type character input device according to claim 11, wherein in case where the depressed position of the touch region is shifted to the other manipulation region, the input language mode is changed and the representative characters of the changed input language mode are allocated to the character sectors of the manipulation region where the input language mode is changed before the depressed state of the touch region is released at the other manipulation region, and one of the representative characters allocated to the character sectors of the other manipulation region is designated as a current character, and
wherein in case where the designated current character is not identical to a character which a user wants to input, when the depressed position of the touch region is shifted to another position at the other manipulation region while maintaining the depressed state of the touch region to cause the character which a user wants to input to be designated as the current character and then the depressed state of the touch region is released, the input language mode of the changed manipulation region is re-changed to an original input language mode and the representative characters of the input language prior to the change of the input language mode are re-allocated to the character sectors of the manipulation region where the input language mode is changed.

13. The touch type character input device according to claim 1, wherein in case where the character designated as the current character is the control character and performs an independent function assigned to the control character, when the control character is selected and the depressed state of the control character of the touch screen is released, the input processing section allows a code of the current character to be transmitted to the main device, wherein in case where the character designated as the current character is the control character and is intended to be simultaneously depressed along with another character, when the control character are selected and the depressed state of the control character of the touch screen is released, the input processing section waists for a current character to be inputted subsequently and then sets a control character input state of allowing a code of the subsequently inputted current character to be transmitted to the main device immediately after a code of the control character, and
wherein when a current character for allowing the control character input state to be terminated is selected in the control character input state and the depressed state of the current character of the touch screen is released, the input processing section transmits a code of the current character for allowing the control character input state to be terminated to the main device immediately after a code of the control character set prior to the current character for allowing the control character input state to be terminated and processes the control character input state to be released.

14. The touch type character input device according to claim 1, wherein in case where the representative characters of the manipulation region include directional keys, when a user depresses a first directional key indicating the direction where the user wants the input position of the main device to be shifted and then releases the depressed state of the touch region, a code of the first direction key is transmitted to the main device,
wherein when the depressed position of the touch region is shifted in one direction at the manipulation region where the first directional key exists while maintaining the depressed state of the touch region, the code of the first direction key is repeatedly transmitted to the main device, and
wherein when the depressed position of the touch region is shifted in an opposite direction at the manipulation region while maintaining the depressed state of the touch region, the code of a second direction key which is shifted in the opposite direction to that of the first directional key is repeatedly transmitted to the main device.

15. The touch type character input device according to claim 1, wherein the representative characters or the associated characters of the representative characters are sequentially designated as the current character within the manipulation region in an adjacent order according to a degree of shift of the depressed position of the touch region within the manipulation region.

16. The touch type character input device according to claim 1 further comprising an input language mode setting section for setting the input language mode or an input language mode display section for displaying the type of the set input language mode.

17. The touch type character input device according to claim 1, wherein when the depressed state of the touch region is released at the outside of the closed curve of the outermost peripheral manipulation region within the touch region, the current character displayed on the character display section is deleted to cancel the entry of the character.

18. The touch type character input device according to claim 1, wherein the touch region of the outside of the closed curve of the outermost peripheral manipulation region is first depressed, the function of the character input device is not performed over the entire touch region but the intrinsic function of the touch region is implemented.
